(19) United States
(12) Patent Application Publication
(10) Pub. No.: US 2026/0141499 A1
(43) Pub. Date: May 21, 2026

(54) HIERARCHICAL MASKED AUTO-REGRESSIVE IMAGE GENERATION

(71) Applicant: NVIDIA Corporation, Santa Clara, CA (US)

(72) Inventors: Hermann Nyuykonge Kumbong, Stanford, CA (US); Xian Liu, Menlo Park, CA (US); David Wilson Romero Guzman, San Francisco, CA (US); Tsung-Yi Lin, Sunnyvale, CA (US); Ming-Yu Liu, Redwood City, CA (US)

(21) Appl. No.: 19/257,996

(22) Filed: Jul. 2, 2025

Related U.S. Application Data
(60) Provisional application No. 63/721,879, filed on Nov. 18, 2024.

(51) Int. Cl. G06T 5/77; G06T 3/4053; G06T 5/50; G06T 5/60

(52) U.S. Cl. CPC G06T 5/77; G06T 3/4053; G06T 5/50; G06T 5/60; G06T 2207/20016; G06T 2207/20081; G06T 2207/20084

(57) ABSTRACT

In various examples, next-scale and masked prediction techniques may be used together (e.g., integrated) in a hierarchical, masked auto-regressive (HMAR) architecture to efficiently generate high-quality images with fast sampling, thereby producing images using fewer steps and less time than conventional techniques. For instance, beginning with an initial, low-resolution version of an image, the systems and methods of the present disclosure may use next-scale prediction to progressively enhance the image through multiple resolution levels. In some examples, this may involve reformulating next-scale prediction as a Markovian process and generating successive image versions based on information from the immediately preceding resolution of the image. Between resolution scaling steps, masked prediction may be used to iteratively refine different portions of the image before advancing to the next resolution level. Based on this multi-step prediction and refinement process, a final, high-fidelity image at a target resolution may be produced quickly and efficiently.

### CROSS-REFERENCE TO RELATED APPLICATIONS

This application claims the benefit of U.S. Provisional Application No. 63/721,879, filed on Nov. 18, 2024, which is hereby incorporated by reference in its entirety and for all purposes.

### BACKGROUND

Autoregressive (AR) techniques may be applied to image generation by modeling the probability distribution of an image as a sequence of conditional predictions. For example, an image may be represented using a series of discrete tokens, each predicted based on the preceding tokens. This approach allows the model to generate structured image content by sequentially sampling one token at a time. AR models may benefit from using architectures originally developed for natural language processing, and they have been adapted to image data through techniques such as vector quantization and transformer-based decoding. These methods may enable the generation of high-fidelity images while preserving consistency with preceding content.

Despite their effectiveness, however, existing AR approaches may exhibit limitations in quality, efficiency, and scalability. For instance, modeling long sequences of image tokens can lead to high computational costs and slow generation, especially for high-resolution images. Additionally, enforcing strict sequential orderings can disrupt spatial relationships within image content, which may result in suboptimal visual coherence. In practice, these constraints may reduce the practicality of AR methods for real-time or high-throughput image generation tasks, and they may limit flexibility in adapting generation strategies without extensive retraining.

### SUMMARY

Embodiments of the present disclosure relate to hierarchical masked auto-regressive image generation. Systems and methods are disclosed for implementing a hierarchical, masked auto-regressive (HMAR) architecture—which may integrate next-scale prediction and masked prediction techniques—to efficiently generate high-quality images with fast sampling, thereby producing images using fewer steps and less time than conventional techniques.

For instance, beginning with an initial, low-resolution version of an image, the systems and methods of the present disclosure may use next-scale prediction to progressively enhance the image through multiple resolution levels. In some examples, this may involve reformulating next-scale prediction as a Markovian process and generating successive image versions based on information from the immediately preceding resolution of the image. Between resolution scaling steps, masked prediction may be used to iteratively refine different portions of the image before advancing to the next resolution level. Based on this multi-step prediction and refinement process, a final, high-fidelity image at a target resolution may be produced quickly and efficiently.

In contrast to conventional systems, the system and methods of the present disclosure may, in some embodiments, be able to generate high-resolution images more efficiently and with improved visual fidelity. For instance, by reformulating next-scale prediction as a Markovian process within the HMAR architecture, the systems and methods of the present disclosure may condition each successive resolution level of an image solely on its immediate predecessor, thereby reducing computational complexity and memory overhead while preserving essential image context. Additionally, by using intra-scale masked prediction, the HMAR system may iteratively refine generated content within each resolution level, capturing finer spatial dependencies that are typically lost in conventional autoregressive approaches. As a result, the systems and methods disclosed herein may achieve faster sampling rates (e.g., 175% faster sampling during inference) and/or a reduced memory footprint (e.g., 300% memory reduction) without sacrificing image quality. Further, the systems and methods of the present disclosure may enable flexible sampling schedules that allow for increased generation steps without necessitating model retraining, thereby facilitating greater adaptability across diverse image generation tasks, including zero-shot image editing. These advantages collectively support more scalable, precise, and high-throughput image synthesis than were previously attainable using conventional autoregressive or diffusion-based techniques.

### BRIEF DESCRIPTION OF THE DRAWINGS

The present systems and methods for hierarchical masked auto-regressive image generation are described in detail below with reference to the attached drawing figures, wherein:

FIG. 1 is a data flow diagram illustrating an example of a process that may be performed using a hierarchical, masked auto-regressive (HMAR) architecture to generate an image, in accordance with some embodiments of the present disclosure;

FIG. 2 illustrates a visualization of integrating next-scale and masked prediction to generate an image, in accordance with some embodiments of the present disclosure;

FIG. 3 illustrates an example of a block-diagonal attention mask pattern, which may be used by the HMAR system, in accordance with some embodiments of the present disclosure;

FIG. 4 is a block diagram illustrating example detail associated with a system that may be used to perform one or more of the processes, methods, or techniques described herein;

FIG. 5 is a flow diagram illustrating an example of a method that may be performed using the HMAR system to generate an image, in accordance with some embodiments of the present disclosure;

FIG. 6 is a flow diagram illustrating another example of a method that may be performed using the HMAR system to generate an image, in accordance with some embodiments of the present disclosure;

FIG. 7 is a block diagram of an example computing device suitable for use in implementing some embodiments of the present disclosure; and

FIG. 8 is a block diagram of an example data center suitable for use in implementing some embodiments of the present disclosure.

### DETAILED DESCRIPTION

Systems and methods are disclosed related to hierarchical masked auto-regressive (HMAR) image generation. For instance, a system(s) may obtain or otherwise receive input data indicating information associated with an image to be generated. In some examples, the input data may represent a class label—such as “flamingo” or “cat” or any other type information indicating what the generated image is supposed to depict. Based on the input data, the system(s) may generate a first version of the image at a first resolution. In some instances, the first resolution may be a relatively low resolution such that the first version of the image may depict the general shape and structure of the intended image with a low level of detail. As an example, assuming the input data represents a label that says “flamingo,” the system(s) may generate the first version of the image at the first resolution such that the image depicts a blurry or coarse version of a flamingo-shaped figure, which may convey the basic outline and posture of the bird but does not yet include fine-grained features such as feathers, beak details, or color variations.

As described herein, in various examples, the system(s) may then use the first version of the image having the first resolution to generate a second version of the image at a second resolution. The second resolution may be higher than the first resolution, and the second version of the image may include additional visual detail not present in the first version. In some instances, the system(s) may generate the second version of the image by performing one or more next-scale prediction techniques. For instance, the system(s) may use the first version of the image as input to one or more next-scale prediction models trained to predict the structure and appearance of the image at the next level of resolution. The resulting second version of the image may preserve the general layout and shape from the first version while introducing additional tokens that provide more capacity for representing detail. However, the new content added during next-scale prediction may be blurry, loosely aligned, or visually noisy, as it may be inferred without fine-grained context. Continuing the flamingo example from above, the system(s) may generate a second version of the flamingo image that includes a rough extension of the legs, broader wing areas, or preliminary suggestions of a beak and feathers, but the added portions may lack definition or spatial precision.

In various examples described herein, the system(s) may represent one or more (e.g., each) versions of the image—at the different resolution levels—as a grid or sequence of discrete units referred to as “tokens.” In some examples, a token may correspond to a visual element or patch of the image, such as a small block of pixels or a quantized feature extracted from a latent representation of the image. In some instances, tokens may be generated using a tokenizer model such as a vector quantized variational autoencoder (VQ-VAE), which may convert continuous image data into a fixed vocabulary of discrete visual codes. Using tokens may allow the system(s) to apply autoregressive and/or masked modeling techniques that operate at the level of these discrete codes, rather than directly on raw pixel values. As such, operations such as next-scale prediction and/or masked refinement may be performed over tokens—in addition to, or in the alternative of, pixel values. Accordingly, references to “portions” of the image herein—such as portions to be predicted, masked, or refined—may refer to image tokens, pixel regions, or other subcomponents of the image at a given resolution level.

Because the process of using next-scale prediction to scale the image between the first resolution and the second resolution may introduce artifacts, inconsistencies, or missing visual details, the system(s) may, in various instances, perform one or more refinement operations to improve the quality of the second version of the image. The refinement operation(s) may include performing one or more masked prediction techniques. In such instances, the system(s) may mask or hide one or more portions of the second version of the image—where the portion(s) may include, for example, one or more tokens, pixel regions, or other subcomponents of the image—and then re-predict the masked portion(s) based on one or more remaining, visible portions (e.g., unmasked portions, tokens, etc.) of the image. Additionally, or alternatively, the system(s) may re-predict the masked portion(s) based on information from the first version of the image. The masked prediction process may be performed by the system(s) in one or more steps or iterations, with different subsets of portions masked and re-predicted during the step(s) (e.g., each step). Over the course of the step(s), the system(s) may iteratively improve local visual features and spatial consistency within the second version of the image. For instance, continuing the flamingo example from above, the system(s) may use masked prediction to sharpen the flamingo's beak and wing outlines, align the legs more accurately with the body, and reduce visual noise in the background—without increasing the second resolution (e.g., number of pixels, tokens, etc.) of the second version of the image.

In some examples, the system(s) may generate a third version of the image at a third resolution based on the refined second version of the image at the second resolution. For instance, based on completing generation and refinement of the second version of the image at the second resolution, the system(s) may continue the image generation process by generating the third version of the image at the third resolution. The third resolution may be higher than the second resolution, and the third version of the image may, in some instances, include additional visual detail not present in the second version. In some examples, the system(s) may generate the third version of the image by performing next-scale prediction based on the refined second version of the image. As with prior steps, this prediction may involve generating one or more new portions of the image—such as tokens, pixel regions, or other subcomponents—that correspond to the higher third resolution. Continuing the flamingo example, the system(s) may generate a third version of the flamingo image that adds new content such as a background tree, more fully drawn tail feathers, or additional leg segmentation, but the new details may, in various instances, initially appear fuzzy or disjointed from the rest of the image.

Additionally, the system(s) may perform one or more refinement operations to improve the quality of the third version of the image. For example, the system(s) may perform masked prediction by masking one or more portions of the third version of the image and re-predicting those masked portions based on the remaining visible portions and/or on the second version of the image. This refinement process may be repeated across multiple steps or iterations, with different subsets of portions masked and re-predicted at one or more (e.g., each) of the steps. Over the course of these steps, the system(s) may improve local visual fidelity, spatial coherence, and structural consistency in the third version of the image without increasing the third resolution. Continuing the flamingo example, the system(s) may use masked prediction to clarify and align tail feather edges, clean up the transition between the flamingo and background tree, and enhance the lighting or shading across the legs and wings to produce a more coherent and realistic visual result.

In some examples, the system(s) may repeat the image scaling and refinement process for one or more additional resolution levels beyond the third resolution, until a target resolution is reached. For instance, the system(s) may generate a fourth version of the image at a fourth resolution by performing next-scale prediction based on the refined third version of the image, followed by one or more masked prediction steps to improve the quality of the fourth version, then a fifth version of the image, and so forth. In such examples, one or more (e.g., each) subsequent resolutions of the image may be higher than the preceding resolution and may introduce new portions of the image—such as additional tokens or pixel regions—that may allow the system(s) to express increasingly fine-grained detail. Continuing the flamingo example, a fourth version of the flamingo image might include finer texturing of individual feathers, more defined eye and beak features, or subtle background elements such as reflections or shadows. The system(s) may then use masked prediction to clean up these elements, ensuring smoother transitions, sharper edges, and improved consistency across the entire image—without increasing the fourth resolution.

In various examples, the system(s) may determine that the image generation process is complete upon reaching the target resolution, a predefined number of resolution levels, a desired quality threshold based on one or more evaluation metrics, and/or some other threshold. For instance, the system(s) may stop generating additional versions of the image once the image has reached a resolution suitable for a given application (e.g., 256×256 pixels, 512×512 pixels, etc.), or once further refinement steps yield minimal improvements in image quality. In some examples, the system(s) may evaluate image quality using one or more scoring functions that analyze token distributions, feature coherence, or perceptual similarity to prior image versions. Alternatively, a user or calling application may explicitly specify a stopping point, such as a target resolution or maximum number of generation steps. Continuing the flamingo example, the system(s) may complete the generation process once the image includes visually complete and coherent flamingo features—such as fully detailed feathers, smooth background transitions, and a properly shaped beak—at a final resolution suitable for display, storage, or downstream use.

In some examples, the HMAR image generation techniques described herein may be applied to a variety of image generation tasks beyond initial image synthesis. For instance, the system(s) may support class-conditional image generation by initializing the process with a class label or category, as described above. Additionally, the system(s) may support conditional image completion by receiving a partially generated image as input and generating one or more refined or completed versions across one or more resolution levels. In additional or alternative examples, the system(s) may support zero-shot editing by modifying specific portions of an image—such as tokens or regions—at one or more resolution levels, while preserving the rest of the image structure. Because the image may be generated in a hierarchical and iterative manner, the system(s) may flexibly modify or regenerate image content at various granularities without needing to reprocess the entire image from scratch. This flexibility may enable more targeted editing, efficient reuse of intermediate outputs, and broader applicability across creative, scientific, or operational image-based workflows.

Although examples may be described herein with respect to using models (e.g., machine learning models), such as neural networks, this is not intended to be limiting. For example, and without limitation, any of the various models and/or neural networks described herein may include any type of machine learning model, such as a machine learning model(s) using linear regression, logistic regression, decision trees, support vector machines (SVM), Naïve Bayes, k-nearest neighbor (Knn), K means clustering, random forest, dimensionality reduction algorithms, gradient boosting algorithms, neural networks (e.g., auto-encoder neural networks, artificial neural networks (ANNs), convolutional neural networks (CNNs), recurrent neural networks (RNNs), perceptrons, Long/Short Term Memory (LSTM) networks, multi-layer perceptron (MLP) networks, deep stacking networks (DSNs), generative pre-training (GPT) models or networks, feed forward networks, radial basis function ANNs, self-organizing maps (SOMs), Kohonen maps, Hopfield networks, Boltzmann machine, deep belief neural networks, deconvolutional neural networks, generative adversarial networks (GANs), liquid state machines, modular neural networks, liquid state machines, sequence-to-sequence models, networks using transformer architectures, state space models (SSMs) (e.g., networks using Mamba architectures (e.g., Mamba-1, Mamba 2, etc.), networks using selective state space models, networks using structured state space sequence models, etc.), diffusion models (e.g., diffusion probabilistic models, score-based generative models, etc.), neural radiance field (NeRF) models, Gaussian splat models, Kolmogorov-Arnold networks (KANs), models with encoder-only architectures, models with decoder-only architectures, models with encoder-decoder architectures, generative machine learning models, language models, large language models (LLMs), vision language models (VLMs), multi-modal language models (MMLMs), large action models (LAMs), vision-language-action (VLA) models, etc.), and/or other types of machine learning models.

Additionally, in some examples, the models (e.g., next-scale prediction models, masked prediction models, neural networks, language models, transformer models, fusion models, diffusion models, encoder-only models, decoder-only models, encoder-decoder models, neural rendering field (NERF) models, etc.) described herein may be packaged as a microservice—such an inference microservice (e.g., NVIDIA NIMs)—which may include a container (e.g., an operating system (OS)-level virtualization package) that may include an application programming interface (API) layer, a server layer, a runtime layer, and/or a model “engine.” For example, the inference microservice may include the container itself and the model(s) (e.g., weights and biases). In some instances, such as where the model(s) is small enough (e.g., has a small enough number of parameters), the model(s) may be included within the container itself. In other examples—such as where the model(s) is large—the model(s) may be hosted/stored in the cloud (e.g., in a data center) and/or may be hosted on-premises and/or at the edge (e.g., on a local server or computing device, but outside of the container). In such embodiments, the model(s) may be accessible via one or more APIs-such as REST APIs. As such, and in some embodiments, the model(s) described herein may be deployed as an inference microservice to accelerate deployment of a model(s) on any cloud, data center, or edge computing system, while ensuring the data is secure. For example, the inference microservice may include one or more APIs, a pre-configured container for simplified deployment, an optimized inference engine (e.g., built using a standardized AI model deployment an execution software, such as NVIDIA's Triton Inference Server, and/or one or more APIs for high performance deep learning inference, which may include an inference runtime and model optimizations that deliver low latency and high throughput for production applications—such as NVIDIA's Tensor®), and/or enterprise management data for telemetry (e.g., including identity, metrics, health checks, and/or monitoring). The model(s) described herein may be included as part of the microservice along with an accelerated infrastructure with the ability to deploy with a single command and/or orchestrate and auto-scale with a container orchestration system on accelerated infrastructure (e.g., on a single device up to data center scale). As such, the inference microservice may include the machine learning model(s) (e.g., that has been optimized for high performance inference), an inference runtime software to execute the machine learning model(s) and provide outputs/responses to inputs (e.g., user queries, prompts, etc.), and enterprise management software to provide health checks, identity, and/or other monitoring. In some embodiments, the inference microservice may include software to perform in-place replacement and/or updating to the model(s). When replacing or updating, the software that performs the replacement/updating may maintain user configurations of the inference runtime software and enterprise management software.

The systems and methods described herein may be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems implementing language models, such as large language models (LLMs), vision language models (VLMs), and/or multi-modal language models, systems implementing one or more vision language models (VLMs), systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems for performing generative AI operations, systems implemented at least partially using cloud computing resources, and/or other types of systems.

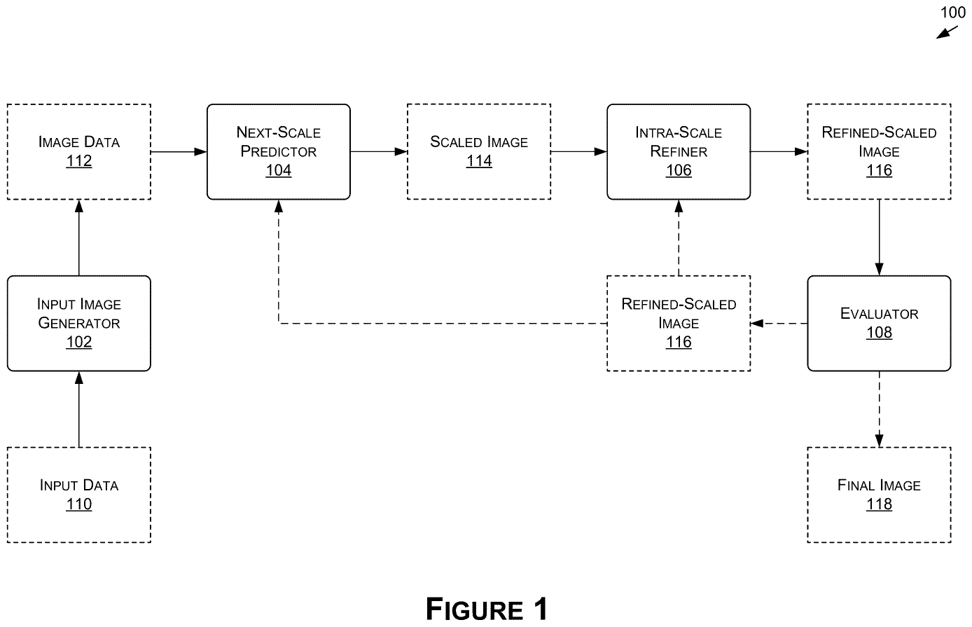

With reference to FIG. 1, FIG. 1 is a data flow diagram illustrating an example of a process 100 that may be performed using an HMAR system to generate an image, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

The process 100 illustrated in the example of FIG. 1 may be implemented using, amongst additional or alternative components, an input image generator 102, a next-scale predictor 104, an intra-scale refiner 106, and an evaluator 108. In some instances, one or more of these components may be associated with (e.g., included in, called by, etc.) the HMAR system. As a brief overview, the process 100 may include the input image generator using input data 110 to generate image data 112 representing an image (e.g., a first version of the image). The next-scale predictor 104 may then use the image data 112 representing the first version of the image to generate a scaled image 114 (e.g., a second version of the image). The intra-scale refiner 106 may then perform one or more masked prediction or other refinement operations on the scaled image 114 to generate a refined-scaled image 116 (e.g., a refined second version of the image at the same resolution). The evaluator 108 may then evaluate the refined-scaled image 116 to determine whether the refined-scaled image 116 should undergo further refinement, be scaled to the next resolution, or be output as a final image 118.

As shown, the process 100 may be repeated one or more times in a looped or staged manner to progressively scale and refine the image across multiple resolution levels. For instance, if the evaluator 108 determines that the refined-scaled image 116 has not yet achieved a threshold level of quality at its current resolution (e.g., additional masked portions remain), the refined-scaled image 116 may be passed back to the intra-scale refiner 106 for one or more additional refinement operations—such as further masked prediction steps—at the same resolution level. These additional refinements may help improve local structure, remove artifacts, or enhance visual coherence without increasing the resolution of the image. Additionally, or alternatively, if the evaluator 108 determines that the refined-scaled image 116 should be scaled to a higher resolution, the refined-scaled image 116 may be passed back to the next-scale predictor 104 to generate a further scaled image at the next resolution level. That image may then again be refined using the intra-scale refiner 106, producing a new refined-scaled image 116 that is subject to further evaluation. This iterative process may continue until the evaluator 108 determines that the image has reached the target resolution or otherwise satisfies a stopping criterion. At that point, the evaluator 108 may designate the current refined-scaled image 116 as the output image 118, which may represent the final high-resolution version of the generated image.

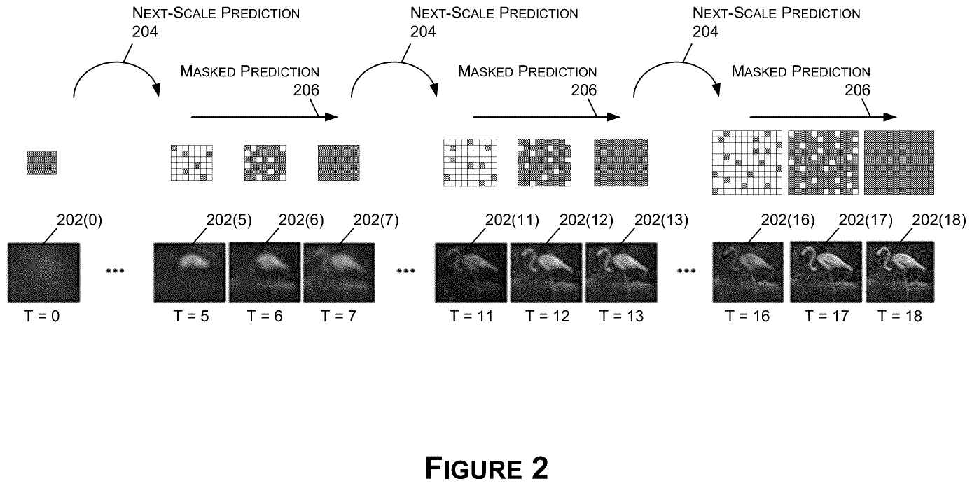

For instance, FIG. 2 illustrates a visualization of integrating next-scale and masked prediction to generate an image, in accordance with some embodiments of the present disclosure. As shown in FIG. 2, at T=0 an initial version of an image at a base resolution (e.g., image 202(0))—which may be generated by the input image generator 102 based on the input data 110 (e.g., a class label). In the illustrated example, the image 202(0) begins as a blurry or low-detail representation of a flamingo. The system may then apply a first instance of next-scale prediction 204 to generate an expanded set of tokens corresponding to a higher resolution image (e.g., image 202(5)). This expanded version may include new regions or features, but may initially be noisy, incomplete, or imprecise, as shown. In the context of FIG. 1, these steps may be performed using the next-scale predictor 104 and intra-scale refiner 106 operating on image data 112.

Following this, the system may perform one or more masked prediction steps 206 to refine the image at the same resolution. As depicted in the token grid above images 202(5)-202(7), masked prediction 206 may involve masking different subsets of tokens in successive steps and re-predicting them based on the surrounding visible tokens (e.g., the shaded tokens). Over multiple iterations (e.g., from T=5 to T=7), the visual output may become clearer and more coherent, as shown in the corresponding image progression.

This process may repeat over multiple resolution levels. For example, at time T=7, another round of next-scale prediction 204 may be used to produce a higher-resolution version of the image (e.g., 202(11)), followed again by multiple masked prediction steps 206 (e.g., 202(12) and 202(13)) that refine the image at that scale. As shown, each application of next-scale prediction 204 may introduce additional tokens and visual content, while masked prediction 206 operations may improve quality and spatial alignment at the current resolution.

In the illustrated example, the process continues through at least three resolution levels, culminating in image 202(18), which appears visually complete, coherent, and detailed. Across these stages, the upper row of token grids in FIG. 2 provides a conceptual depiction of token masking patterns used during masked prediction at each resolution level. In some examples, these patterns may be determined using confidence scores, random sampling, or learned masking schedules.

Now referring back to the example of FIG. 1, in some examples, the input image generator 102 may be configured to generate initial image data 112 based on received input data 110. The input data 110 may include, for example, a class label or category (e.g., “flamingo,” “dog,” “car”), a segmentation map, a style embedding, a layout sketch, or any other type of input used to guide or condition image generation. In some examples, the input image generator 102 may use a pretrained class-conditional transformer or embedding module to translate the input data 110 into a low-resolution representation of an image, such as a token map or latent embedding at a base scale. This may correspond to the first version of the image and may, in some instances, define the initial visual context for subsequent scaling and refinement operations. The image data 112 output by the input image generator 102 may therefore serve as the starting point for hierarchical generation by the HMAR system.

In some examples, the input image generator 102 may operate by embedding the input data 110 into a latent token space using a learned encoder, such as a VQ-VAE or transformer-based embedder, or any other learned encoder. The resulting image data 112 may comprise a discrete grid of tokens that define the semantic layout, class context, or coarse spatial structure of the image to be generated. For instance, a label such as “flamingo” may be mapped to a low-resolution token grid that implicitly encodes posture, viewpoint, or silhouette. This token grid may serve not only as a structural basis for the image, but also as a conditioning context for subsequent resolution levels. In some examples, the input image generator 102 may support multiple modalities of input—such as joint text and segmentation masks—allowing it to guide generation from rich or composite cues.

Additionally, the input image generator 102 may leverage pretrained foundation models for encoding class labels or textual prompts into embeddings that align with the learned token space of the downstream components. This alignment may ensure semantic consistency across resolution levels and allow efficient integration with autoregressive or masked prediction models. In examples where the input data 110 includes a partial image, the generator 102 may also preserve existing tokens and mask undefined regions for completion in later stages.

As described herein, the next-scale predictor 104 may, in some examples, be configured to receive the image data 112 and/or the refined scaled image 116 and generate the scaled image 114 at a higher resolution than these inputs. The next-scale predictor 104 may, in some examples, operate as a Markovian autoregressive model that performs next-scale prediction conditioned on (e.g., only on) the immediately preceding resolution level of the image, in contrast to the entire generation history. In some examples, the next-scale predictor 104 may generate the scaled image 114 by predicting a residual token map that, when combined with the upsampled prior image, may approximate the image content at the higher resolution. This prediction may, in some examples, be implemented using a transformer-based architecture with block-diagonal attention, which may significantly reduce memory and computational cost compared to traditional block-causal attention patterns. The scaled image 114 may contain additional tokens representing finer structure, but may also introduce inconsistencies or artifacts that require refinement.

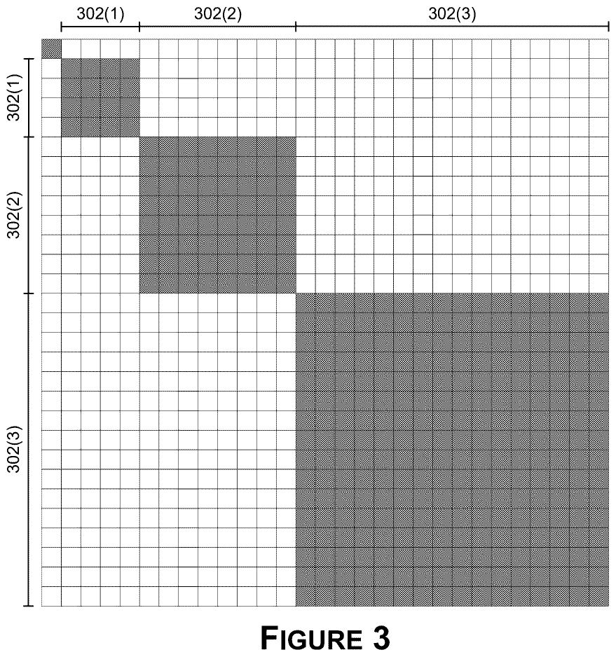

Additionally, in some cases, the next-scale predictor 104 may use block-diagonal attention mechanisms (such as those described in the example of FIG. 3), which may restrict cross-token attention to localized windows or diagonals. This attention design may preserve locality while reducing the computational complexity of self-attention, enabling efficient operation at high resolutions. Additionally, the next-scale model may be trained using scale-specific loss functions or auxiliary objectives (e.g., perceptual similarity to full-resolution ground truth) that improve generation fidelity.

For instance, FIG. 3 illustrates an example of a block-diagonal attention mask pattern, which may be used by the HMAR system, in accordance with some embodiments of the present disclosure. As shown, the attention mask may be represented as a square matrix, with rows and columns corresponding to tokens associated with different resolution levels (or scales) of an image. The shaded blocks in the matrix indicate token pairs for which attention may be permitted, while the unshaded areas indicate token pairs for which attention may be masked or disallowed.

In the example of FIG. 3, the attention mask includes three distinct diagonal blocks each corresponding to tokens at different resolution scales. Each diagonal block is square and self-contained, indicating that during generation at a particular resolution scale, tokens may only be allowed to attend to other tokens from the immediately preceding scale. For instance, tokens in the third scale 302(3) may attend only to tokens from the second scale 302(2), and not to tokens from the first scale 302(1). This block-diagonal attention configuration may be used by the next-scale predictor 104 (e.g., during next-scale prediction) to enable localized and efficient attention computation. By restricting cross-token attention to only the immediately preceding resolution level, the system may avoid the cost of global attention across all tokens from all scales. As a result, the attention mask may become increasingly sparse as resolution increases—reducing memory footprint and computational overhead.

In contrast to full or block-causal attention patterns, which may require attending to a broad range of prior tokens, the illustrated block-diagonal pattern supports a scalable and resolution-aware approach to autoregressive image generation. As the number of tokens grows with higher resolutions, the proportional sparsity of the attention mask increases, further improving computational efficiency. This makes the approach particularly well-suited for high-resolution image generation tasks, where dense attention would be prohibitively expensive. Accordingly, by adopting the block-diagonal attention pattern shown in FIG. 3, the HMAR system may achieve a balance between contextual awareness and scalability, enabling efficient and structured generation across multiple resolution levels.

Referring back to the example of FIG. 1, the intra-scale refiner 106 may, in various instances, be configured to improve the visual quality of the scaled image 114 by performing masked prediction operations to generate the refined-scaled image 116. The intra-scale refiner 106 may, in some examples, apply a multi-step masked generation process (e.g., MaskGIT or similar processes), where different subsets of tokens in the scaled image 114 are masked and then re-predicted over multiple refinement steps. During one or more (e.g., each) of the refinement steps, the masked prediction model may condition its predictions on the unmasked tokens within the current scale and the cumulative image context from previous resolution levels. The refinement process may progressively reduce visual noise, sharpen features, and improve spatial coherence without increasing resolution. The resulting refined-scaled image 116 may more accurately reflect the intended structure and appearance at the current scale, and may be passed to the evaluator 108 for further processing.

In some examples, the masking pattern used by the intra-scale refiner 106 may vary between rounds, such as being random, confidence-based, or learned from training data. Additionally, in some examples, the masking schedule may begin with a higher masking ratio (e.g., 50%) and gradually reduce it in later rounds to allow coarse-to-fine refinement. In some instances, each round of masked prediction may be informed by prior resolution context, such as embeddings from the lower-scale image, or cross-resolution alignment cues. This may allow the model to “anchor” its refinements against earlier structure while flexibly improving within the current resolution. The intra-scale refiner 106 may also include attention across spatial and resolution axes to reconcile inconsistencies and sharpen details—especially important when tokens at the current scale have been newly introduced by the next-scale predictor 104. In further examples, the intra-scale refiner 106 may optionally modify a subset of regions within the scaled image 114—such as low-confidence areas, feature boundaries, or salient object parts—based on learned or heuristic criteria. This may enable targeted refinement without redundant computation across high-confidence areas.

In some examples, the evaluator 108 may receive the refined-scaled image 116 and determine whether additional refinement is needed at the current resolution, whether the image should be passed back to the next-scale predictor 104 to scale up to the next resolution level, or whether the image is ready for output. The evaluator 108 may perform this determination based on various quality metrics, such as token confidence, feature alignment, residual entropy, or similarity to prior scales. In some instances, the evaluator 108 may implement one or more scoring functions or learned decision modules that compare the current refined-scaled image 116 against predefined thresholds or dynamic targets. The function(s) may include token confidence scores (e.g., softmax probabilities), perceptual similarity to earlier versions (e.g., SSIM or LPIPS), and/or learned heuristics based on downstream utility (e.g., task-specific accuracy). In some examples, the evaluator 108 may maintain a quality threshold that may be required to be met before progression to the next resolution scale. Additionally, in some instances, the evaluator 108 may implement an adaptive control mechanism that adjusts the number of refinement steps or the choice of refinement model based on current image characteristics. For example, if certain regions of the image exhibit high entropy or inconsistency across resolution levels, the evaluator 108 may instruct the intra-scale refiner 106 to apply more iterations or use a higher-capacity refinement model. In contrast, if visual quality stabilizes, the evaluator 108 may fast-track to the next resolution. In some cases, the evaluator 108 may perform multi-resolution consistency checks, comparing structure across different versions of the image to detect and correct drift, jitter, and/or misalignment. This may help ensure that the image evolves coherently across scales and that visual artifacts introduced at one level do not propagate unchecked to higher levels.

Although examples may be described herein with respect to using machine learning models (e.g., next-scale prediction model, masked prediction model), this is not intended to be limiting. For example, and without limitation, any of the various models and/or neural networks described herein may include any type of machine learning model, such as a machine learning model(s) using linear regression, logistic regression, decision trees, support vector machines (SVM), Naïve Bayes, k-nearest neighbor (Knn), K means clustering, random forest, dimensionality reduction algorithms, gradient boosting algorithms, neural networks (e.g., auto-encoder neural networks, artificial neural networks (ANNs), convolutional neural networks (CNNs), recurrent neural networks (RNNs), perceptrons, Long/Short Term Memory (LSTM) networks, multi-layer perceptron (MLP) networks, deep stacking networks (DSNs), generative pre-training (GPT) models or networks, feed forward networks, radial basis function ANNs, self-organizing maps (SOMs), Kohonen maps, Hopfield networks, Boltzmann machine, deep belief neural networks, deconvolutional neural networks, generative adversarial networks (GANs), liquid state machines, modular neural networks, liquid state machines, sequence-to-sequence models, networks using transformer architectures, state space models (SSMs) (e.g., networks using Mamba architectures (e.g., Mamba-1, Mamba 2, etc.), networks using selective state space models, networks using structured state space sequence models, etc.), diffusion models (e.g., diffusion probabilistic models, score-based generative models, etc.), neural radiance field (NeRF) models, Gaussian splat models, Kolmogorov-Arnold networks (KANs), models with encoder-only architectures, models with decoder-only architectures, models with encoder-decoder architectures, generative machine learning models, language models, large language models (LLMs), vision language models (VLMs), multi-modal language models (MMLMs), large action models (LAMs), vision-language-action (VLA) models, etc.), and/or other types of machine learning models.

Additionally, in some examples, the models (e.g., next-scale prediction models, masked prediction models, neural networks, language models, transformer models, fusion models, diffusion models, encoder-only models, decoder-only models, encoder-decoder models, neural rendering field (NERF) models, etc.) described herein may be packaged as a microservice—such an inference microservice (e.g., NVIDIA NIMs)—which may include a container (e.g., an operating system (OS)-level virtualization package) that may include an application programming interface (API) layer, a server layer, a runtime layer, and/or a model “engine.” For example, the inference microservice may include the container itself and the model(s) (e.g., weights and biases). In some instances, such as where the model(s) is small enough (e.g., has a small enough number of parameters), the model(s) may be included within the container itself. In other examples—such as where the model(s) is large—the model(s) may be hosted/stored in the cloud (e.g., in a data center) and/or may be hosted on-premises and/or at the edge (e.g., on a local server or computing device, but outside of the container). In such embodiments, the model(s) may be accessible via one or more APIs-such as REST APIs. As such, and in some embodiments, the model(s) described herein may be deployed as an inference microservice to accelerate deployment of a model(s) on any cloud, data center, or edge computing system, while ensuring the data is secure. For example, the inference microservice may include one or more APIs, a pre-configured container for simplified deployment, an optimized inference engine (e.g., built using a standardized AI model deployment an execution software, such as NVIDIA's Triton Inference Server, and/or one or more APIs for high performance deep learning inference, which may include an inference runtime and model optimizations that deliver low latency and high throughput for production applications—such as NVIDIA's Tensor®), and/or enterprise management data for telemetry (e.g., including identity, metrics, health checks, and/or monitoring). The model(s) described herein may be included as part of the microservice along with an accelerated infrastructure with the ability to deploy with a single command and/or orchestrate and auto-scale with a container orchestration system on accelerated infrastructure (e.g., on a single device up to data center scale). As such, the inference microservice may include the machine learning model(s) (e.g., that has been optimized for high performance inference), an inference runtime software to execute the machine learning model(s) and provide outputs/responses to inputs (e.g., user queries, prompts, etc.), and enterprise management software to provide health checks, identity, and/or other monitoring. In some embodiments, the inference microservice may include software to perform in-place replacement and/or updating to the model(s). When replacing or updating, the software that performs the replacement/updating may maintain user configurations of the inference runtime software and enterprise management software.

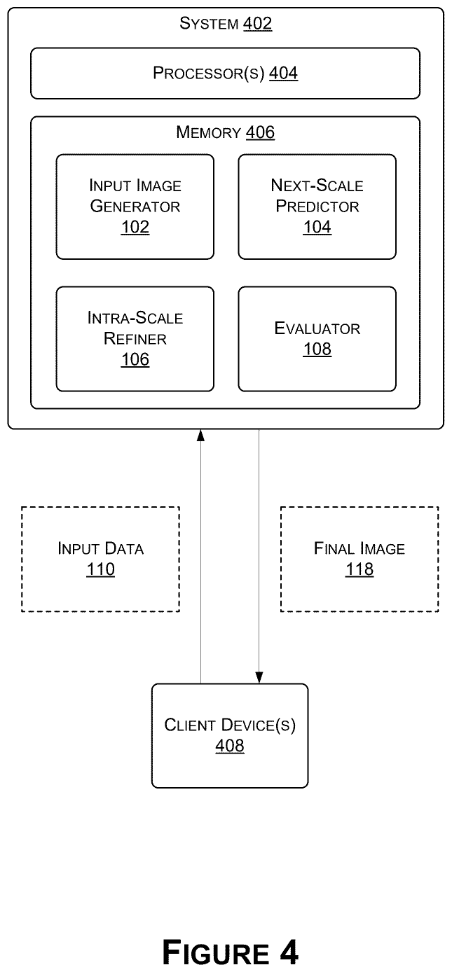

Now referring to FIG. 4, FIG. 4 is a block diagram illustrating example detail associated with a system 402 that may be used to perform one or more of the processes, methods, or techniques described herein. As shown, the system 402, which may be representative of the HMAR systems or architectures described herein, may include one or more processor(s) 404 (which may correspond to the one or more CPUs 706 and/or the one or more GPUs 708 of the example computing device 700) and memory 406 (which may correspond to the memory 704 of the example computing device 700). In various examples, the processor(s) 404 may execute one or more software components stored in the memory 406 to carry out one or more of the methods or operations described herein. For instance, the software component(s) stored in the memory 406 may include one or more of the input image generator 102, the next-scale predictor 104, the intra-scale refiner 106, and/or the evaluator 108, and the processor(s) 404 may execute one or more of these components to generate images in accordance with the techniques disclosed herein.

For instance, the system 402 may receive input data 110 from one or more client devices 408. The input data 110 may represent, among other things, a label (e.g., “flamingo,” “dog,” “car,” etc.), an image, a segmentation map, a style vector, a layout sketch, or any other type of information used to guide the image generation process. Upon receiving the input data 110, the system 402 may use the input image generator 102 to generate initial image data (e.g., a low-resolution token grid or latent embedding) corresponding to a first version of the image. The system 402 may then use the next-scale predictor 104 and the intra-scale refiner 106 to iteratively generate and refine higher-resolution versions of the image, as described in connection with FIGS. 1-3. At one or more stages, the evaluator 108 may assess image quality and determine whether further refinement or scaling is required.

Once the image satisfies a stopping criterion—such as reaching a target resolution or achieving a desired quality threshold—the system 402 may output a final image 118 to the client device(s) 408. The final image 118 may be stored, displayed, or further processed by the client device(s) 408 in accordance with a particular application. In some examples, the image generation process may occur entirely within system 402, while in additional or alternative examples, one or more components (e.g., refinement models or upscaling modules) may be executed remotely or in a distributed fashion, such as in a cloud computing environment. Accordingly, the system 402 shown in FIG. 4 may serve as an example implementation environment for performing HMAR image generation according to the methods described throughout the present disclosure.

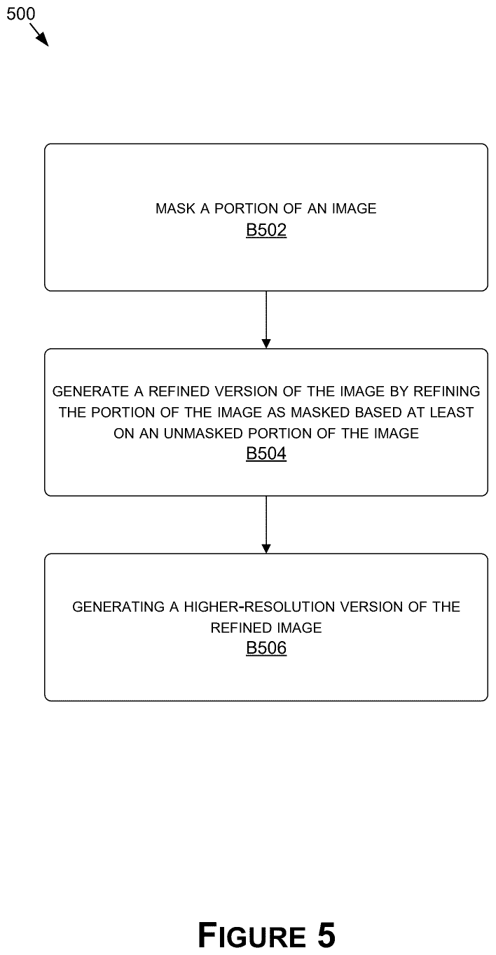

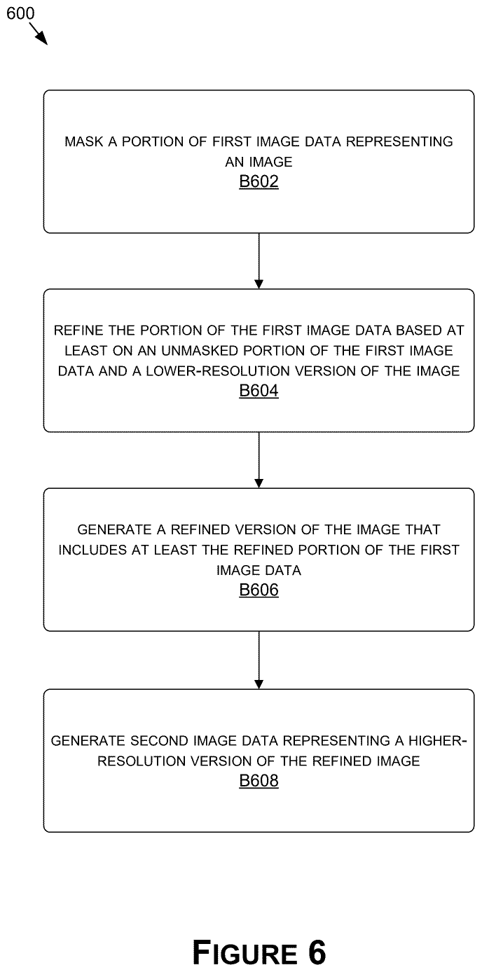

Now referring to FIGS. 5 and 6, each block of methods 500 and 600, described herein, comprises a computing process that may be performed using any combination of hardware, firmware, and/or software. For instance, various functions may be carried out by a processor executing instructions stored in memory. The methods may also be embodied as computer-usable instructions stored on computer storage media. The methods may be provided by a standalone application, a service or hosted service (standalone or in combination with another hosted service), or a plug-in to another product, to name a few. In addition, methods 500 and 600 are described, by way of example, with respect to the system of FIG. 1 and/or FIG. 4. However, the methods may additionally or alternatively be executed by any one system, or any combination of systems, including, but not limited to, those described herein.

Referring first to FIG. 5, FIG. 5 is a flow diagram illustrating an example of a method 500 that may be performed using the HMAR system to generate an image, in accordance with some embodiments of the present disclosure. The method 500, at block B502, may include masking a portion of an image. For instance, the intra-scale refiner 106 may mask one or more portions (e.g., tokens, pixels, etc.) of the scaled image 114. As described herein, in some examples, the portion of the image may be masked by applying a masking pattern that is random, confidence-based, learned, or otherwise designed to guide refinement of uncertain or incomplete areas of the image.

The method 500, at block B504, may include generating a refined version of the image by refining the portion of the image as masked based at least on an unmasked portion of the image. For example, the intra-scale refiner 106 may generate the refined-scaled image 116 by refining (e.g., iteratively refining) the masked portions of the scaled image 114 based at least on one or more unmasked portions of the scaled image 114. In some instances, the refined version of the image may be generated by performing one or more rounds of masked prediction conditioned on both local context (e.g., nearby visible tokens) and optionally on embeddings or features derived from lower-resolution versions of the image.

The method 500, at block B506, may include generating a higher-resolution version of the refined image. For instance, the next-scale predictor 104 may use the refined-scaled image 116 to generate another version of the scaled image 114 that has a higher resolution than the refined-scaled image 116. In some examples, the higher-resolution version of the refined image may be generated by performing next-scale prediction to introduce additional tokens or image portions that expand the spatial resolution, followed optionally by further refinement at the new resolution level.

Now referring to FIG. 6, FIG. 6 is a flow diagram illustrating another example of a method 600 that may be performed using the HMAR system to generate an image, in accordance with some embodiments of the present disclosure. The method 600, at block B602, may include masking a portion of first image data representing an image. For instance, the intra-scale refiner 106 may mask one or more portions of the scaled image 114 (e.g., a set of tokens or pixel regions) in order to prepare for refinement. This masking step may allow the system to focus its generative capacity on regions likely to benefit from correction or enhancement, such as low-confidence areas or visually inconsistent regions.

The method 600, at block B604, may include refining the portion of the first image data based at least on an unmasked portion of the first image data and a lower-resolution version of the image. For example, the intra-scale refiner 106 may generate replacement values for the masked portions by conditioning on both the visible tokens within the same resolution and contextual information derived from the lower-resolution image version (e.g., image data 112 or a previous refined-scaled image 116). This step may help align new visual details with prior structure and improve local coherence without increasing the resolution.

The method 600, at block B606, may include generating a refined version of the image that includes at least the refined portion of the first image data. For instance, the intra-scale refiner 106 may output the refined-scaled image 116 that includes updated token values for the previously masked regions. The resulting refined image may offer improved perceptual quality, enhanced feature consistency, and/or greater readiness for further processing or evaluation.

The method 600, at block B608, may include generating second image data representing a higher-resolution version of the refined image. For example, the next-scale predictor 104 may use the refined-scaled image 116 as input to produce a scaled image 114 at a higher resolution, effectively adding new tokens that increase the image's representational capacity. This upsampling step may introduce new spatial detail or structure that may later be refined, enabling progressive generation of high-resolution output in a staged and coherent manner.

### Example Computing Device

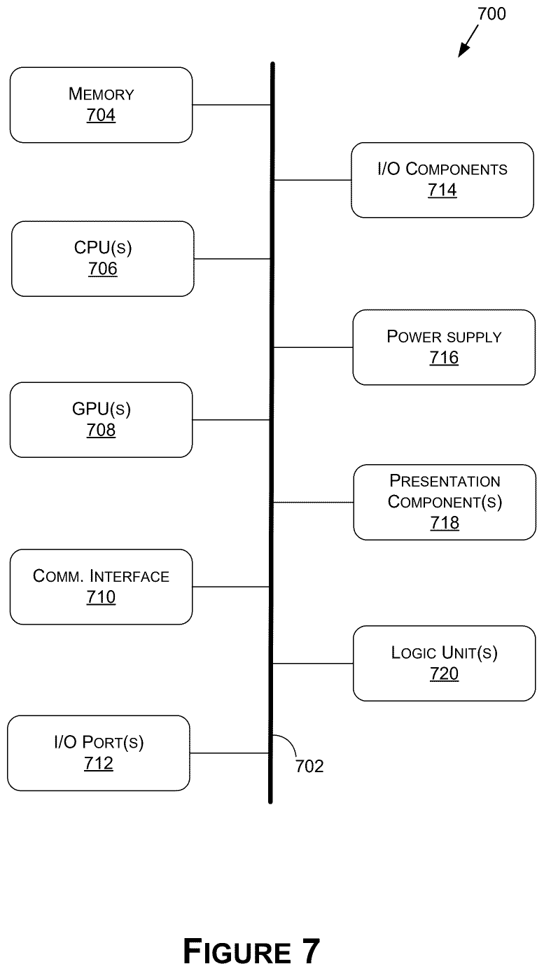

FIG. 7 is a block diagram of an example computing device(s) 700 suitable for use in implementing some embodiments of the present disclosure. Computing device 700 may include an interconnect system 702 that directly or indirectly couples the following devices: memory 704, one or more central processing units (CPUs) 706, one or more graphics processing units (GPUs) 708, a communication interface 710, input/output (I/O) ports 712, input/output components 714, a power supply 716, one or more presentation components 718 (e.g., display(s)), and one or more logic units 720. In at least one embodiment, the computing device(s) 700 may comprise one or more virtual machines (VMs), and/or any of the components thereof may comprise virtual components (e.g., virtual hardware components). For non-limiting examples, one or more of the GPUs 708 may comprise one or more vGPUs, one or more of the CPUs 706 may comprise one or more vCPUs, and/or one or more of the logic units 720 may comprise one or more virtual logic units. As such, a computing device(s) 700 may include discrete components (e.g., a full GPU dedicated to the computing device 700), virtual components (e.g., a portion of a GPU dedicated to the computing device 700), or a combination thereof.

Although the various blocks of FIG. 7 are shown as connected via the interconnect system 702 with lines, this is not intended to be limiting and is for clarity only. For example, in some embodiments, a presentation component 718, such as a display device, may be considered an I/O component 714 (e.g., if the display is a touch screen). As another example, the CPUs 706 and/or GPUs 708 may include memory (e.g., the memory 704 may be representative of a storage device in addition to the memory of the GPUs 708, the CPUs 706, and/or other components). In other words, the computing device of FIG. 7 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 7.

The interconnect system 702 may represent one or more links or busses, such as an address bus, a data bus, a control bus, or a combination thereof. The interconnect system 702 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 706 may be directly connected to the memory 704. Further, the CPU 706 may be directly connected to the GPU 708. Where there is direct, or point-to-point connection between components, the interconnect system 702 may include a PCIe link to carry out the connection. In these examples, a PCI bus need not be included in the computing device 700.

The memory 704 may include any of a variety of computer-readable media. The computer-readable media may be any available media that may be accessed by the computing device 700. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 704 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 700. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 706 may be configured to execute at least some of the computer-readable instructions to control one or more components of the computing device 700 to perform one or more of the methods and/or processes described herein. The CPU(s) 706 may each include one or more cores (e.g., one, two, four, eight, twenty-eight, seventy-two, etc.) that are capable of handling a multitude of software threads simultaneously. The CPU(s) 706 may include any type of processor, and may include different types of processors depending on the type of computing device 700 implemented (e.g., processors with fewer cores for mobile devices and processors with more cores for servers). For example, depending on the type of computing device 700, the processor may be an Advanced RISC Machines (ARM) processor implemented using Reduced Instruction Set Computing (RISC) or an x86 processor implemented using Complex Instruction Set Computing (CISC). The computing device 700 may include one or more CPUs 706 in addition to one or more microprocessors or supplementary co-processors, such as math co-processors.

In addition to or alternatively from the CPU(s) 706, the GPU(s) 708 may be configured to execute at least some of the computer-readable instructions to control one or more components of the computing device 700 to perform one or more of the methods and/or processes described herein. One or more of the GPU(s) 708 may be an integrated GPU (e.g., with one or more of the CPU(s) 706 and/or one or more of the GPU(s) 708 may be a discrete GPU. In embodiments, one or more of the GPU(s) 708 may be a coprocessor of one or more of the CPU(s) 706. The GPU(s) 708 may be used by the computing device 700 to render graphics (e.g., 3D graphics) or perform general purpose computations. For example, the GPU(s) 708 may be used for General-Purpose computing on GPUs (GPGPU). The GPU(s) 708 may include hundreds or thousands of cores that are capable of handling hundreds or thousands of software threads simultaneously. The GPU(s) 708 may generate pixel data for output images in response to rendering commands (e.g., rendering commands from the CPU(s) 706 received via a host interface). The GPU(s) 708 may include graphics memory, such as display memory, for storing pixel data or any other suitable data, such as GPGPU data. The display memory may be included as part of the memory 704. The GPU(s) 708 may include two or more GPUs operating in parallel (e.g., via a link). The link may directly connect the GPUs (e.g., using NVLINK) or may connect the GPUs through a switch (e.g., using NVSwitch). When combined together, each GPU 708 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 706 and/or the GPU(s) 708, the logic unit(s) 720 may be configured to execute at least some of the computer-readable instructions to control one or more components of the computing device 700 to perform one or more of the methods and/or processes described herein. In embodiments, the CPU(s) 706, the GPU(s) 708, and/or the logic unit(s) 720 may discretely or jointly perform any combination of the methods, processes and/or portions thereof. One or more of the logic units 720 may be part of and/or integrated in one or more of the CPU(s) 706 and/or the GPU(s) 708 and/or one or more of the logic units 720 may be discrete components or otherwise external to the CPU(s) 706 and/or the GPU(s) 708. In embodiments, one or more of the logic units 720 may be a coprocessor of one or more of the CPU(s) 706 and/or one or more of the GPU(s) 708.

Examples of the logic unit(s) 720 include one or more processing cores and/or components thereof, such as Data Processing Units (DPUs), Tensor Cores (TCs), Tensor Processing Units(TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 710 may include one or more receivers, transmitters, and/or transceivers that enable the computing device 700 to communicate with other computing devices via an electronic communication network, included wired and/or wireless communications. The communication interface 710 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 720 and/or communication interface 710 may include one or more data processing units (DPUs) to transmit data received over a network and/or through interconnect system 702 directly to (e.g., a memory of) one or more GPU(s) 708.

The I/O ports 712 may enable the computing device 700 to be logically coupled to other devices including the I/O components 714, the presentation component(s) 718, and/or other components, some of which may be built in to (e.g., integrated in) the computing device 700. Illustrative I/O components 714 include a microphone, mouse, keyboard, joystick, game pad, game controller, satellite dish, scanner, printer, wireless device, etc. The I/O components 714 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 700. The computing device 700 may be include depth cameras, such as stereoscopic camera systems, infrared camera systems, RGB camera systems, touchscreen technology, and combinations of these, for gesture detection and recognition. Additionally, the computing device 700 may include accelerometers or gyroscopes (e.g., as part of an inertia measurement unit (IMU)) that enable detection of motion. In some examples, the output of the accelerometers or gyroscopes may be used by the computing device 700 to render immersive augmented reality or virtual reality.

The power supply 716 may include a hard-wired power supply, a battery power supply, or a combination thereof. The power supply 716 may provide power to the computing device 700 to enable the components of the computing device 700 to operate.

The presentation component(s) 718 may include a display (e.g., a monitor, a touch screen, a television screen, a heads-up-display (HUD), other display types, or a combination thereof), speakers, and/or other presentation components. The presentation component(s) 718 may receive data from other components (e.g., the GPU(s) 708, the CPU(s) 706, DPUs, etc.), and output the data (e.g., as an image, video, sound, etc.).

### Example Data Center

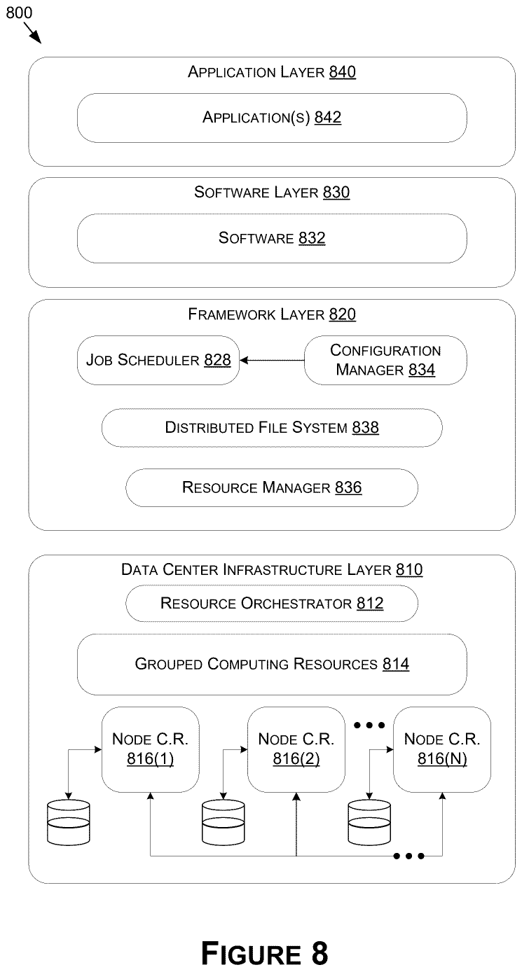

FIG. 8 illustrates an example data center 800 that may be used in at least one embodiments of the present disclosure. The data center 800 may include a data center infrastructure layer 810, a framework layer 820, a software layer 830, and/or an application layer 840.

As shown in FIG. 8, the data center infrastructure layer 810 may include a resource orchestrator 812, grouped computing resources 814, and node computing resources (“node C.R.s”) 816(1)-816(N), where “N” represents any whole, positive integer. In at least one embodiment, node C.R.s 816(1)-816(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 816(1)-816(N) may correspond to a server having one or more of the above-mentioned computing resources. In addition, in some embodiments, the node C.R.s 816(1)-8161(N) may include one or more virtual components, such as vGPUs, vCPUs, and/or the like, and/or one or more of the node C.R.s 816(1)-816(N) may correspond to a virtual machine (VM).

In at least one embodiment, grouped computing resources 814 may include separate groupings of node C.R.s 816 housed within one or more racks (not shown), or many racks housed in data centers at various geographical locations (also not shown). Separate groupings of node C.R.s 816 within grouped computing resources 814 may include grouped compute, network, memory or storage resources that may be configured or allocated to support one or more workloads. In at least one embodiment, several node C.R.s 816 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 812 may configure or otherwise control one or more node C.R.s 816(1)-816(N) and/or grouped computing resources 814. In at least one embodiment, resource orchestrator 812 may include a software design infrastructure (SDI) management entity for the data center 800. The resource orchestrator 812 may include hardware, software, or some combination thereof.

In at least one embodiment, as shown in FIG. 8, framework layer 820 may include a job scheduler 828, a configuration manager 834, a resource manager 836, and/or a distributed file system 838. The framework layer 820 may include a framework to support software 832 of software layer 830 and/or one or more application(s) 842 of application layer 840. The software 832 or application(s) 842 may respectively include web-based service software or applications, such as those provided by Amazon Web Services, Google Cloud and Microsoft Azure. The framework layer 820 may be, but is not limited to, a type of free and open-source software web application framework such as Apache Spark™ (hereinafter “Spark”) that may utilize distributed file system 838 for large-scale data processing (e.g., “big data”). In at least one embodiment, job scheduler 828 may include a Spark driver to facilitate scheduling of workloads supported by various layers of data center 800. The configuration manager 834 may be capable of configuring different layers such as software layer 830 and framework layer 820 including Spark and distributed file system 838 for supporting large-scale data processing. The resource manager 836 may be capable of managing clustered or grouped computing resources mapped to or allocated for support of distributed file system 838 and job scheduler 828. In at least one embodiment, clustered or grouped computing resources may include grouped computing resource 814 at data center infrastructure layer 810. The resource manager 836 may coordinate with resource orchestrator 812 to manage these mapped or allocated computing resources.

In at least one embodiment, software 832 included in software layer 830 may include software used by at least portions of node C.R.s 816(1)-816(N), grouped computing resources 814, and/or distributed file system 838 of framework layer 820. One or more types of software may include, but are not limited to, Internet web page search software, e-mail virus scan software, database software, and streaming video content software.

In at least one embodiment, application(s) 842 included in application layer 840 may include one or more types of applications used by at least portions of node C.R.s 816(1)-816(N), grouped computing resources 814, and/or distributed file system 838 of framework layer 820. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 834, resource manager 836, and resource orchestrator 812 may implement any number and type of self-modifying actions based on any amount and type of data acquired in any technically feasible fashion. Self-modifying actions may relieve a data center operator of data center 800 from making possibly bad configuration decisions and possibly avoiding underutilized and/or poor performing portions of a data center.

The data center 800 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 800. In at least one embodiment, trained or deployed machine learning models corresponding to one or more neural networks may be used to infer or predict information using resources described above with respect to the data center 800 by using weight parameters calculated through one or more training techniques, such as but not limited to those described herein.

In at least one embodiment, the data center 800 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 700 of FIG. 7—e.g., each device may include similar components, features, and/or functionality of the computing device(s) 700. In addition, where backend devices (e.g., servers, NAS, etc.) are implemented, the backend devices may be included as part of a data center 800, an example of which is described in more detail herein with respect to FIG. 8.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 700 described herein with respect to FIG. 7. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

### EXAMPLE CLAUSES

A. A method comprising: masking a portion of an image; generating a refined version of the image based at least on refining the portion of the image as masked using an unmasked portion of the image; and generating, using the refined version of the image, a higher-resolution version of the image.
B. The method of paragraph A, further comprising: generating the image based on upsampling a lower-resolution version of the image; and wherein the generating of the refined version of the image is further based on using the lower-resolution version of the image to refine the portion of the image as masked.
C. The method of any one of paragraphs A-B, further comprising: masking a portion of a second image, the second image corresponding to the higher-resolution version of the refined image; and generating a refined version of the second image by refining the portion of the second image as masked based at least on an unmasked portion of the second image.
D. The method of any one of paragraphs A-C, further comprising: generating, as a third image, a higher-resolution version of the refined second image; and causing output of the third image on a display associated with a computing device.
E. The method of any one of paragraphs A-D, wherein the generating of the refined version of the image comprises performing a plurality of refinement iterations, the method further comprising: determining that a number of the refinement iterations meets or exceeds a threshold, wherein the generating of the higher-resolution version of the refined image is based at least on the number meeting or exceeding the threshold.
F. The method of any one of paragraphs A-E, wherein the generating of the refined version of the image comprises iteratively refining respective ones of a plurality of masked portions of the image over a plurality of refinement steps based at least on a plurality of unmasked portions of the image.
G. The method of any one of paragraphs A-F, wherein the portion of the image as masked comprises one or more masked tokens corresponding to one or more points or pixels of the image, the one or more masked tokens selected based at least on a masking pattern.
H. The method of any one of paragraphs A-G, wherein the generating of the refined version of the image comprises predicting, using a predictive model and based at least on the unmasked portion of the image, a value of a token corresponding to a point or pixel within the portion of the image as masked, where the predictive model is trained to generate one or more token values based on one or more contextual tokens included in the unmasked portion of the image.
I. The method of any one of paragraphs A-H, wherein the image is progressively refined and upsampled through a hierarchy of two or more resolution levels to generate an updated version of the image having a target resolution.
J. A system comprising: one or more processors to: mask a portion of first image data representing an image; refine the portion of the first image data based at least on an unmasked portion of the first image data and a lower-resolution version of the image; generate a refined version of the image that includes at least the portion of the first image data as refined; and generate second image data representing a higher-resolution version of the refined image.
K. The system of paragraph J, the one or more processors further to: mask one or more second portions of the first image data; and refine the one or more second portions of the first image data over one or more iterations based at least on one or more second unmasked portion of the first image data and the lower-resolution version of the image, wherein the refined version of the image further includes the refined one or more second portions.
L. The system of any one of paragraphs J-K, the one or more processors further to: select, based at least on a masking pattern, one or more tokens corresponding to one or more points or pixels included in the portion of the first image data, wherein the masking of the portion of the first image data is based at least on the selection.
M. The system of any one of paragraphs J-L, wherein the masking pattern is selected randomly or determined based on a refinement schedule.
N. The system of any one of paragraphs J-M, wherein the refinement of the portion of the first image data comprises predicting a value of a token corresponding to a pixel of the first image data as masked using a predictive model trained to generate token values based on contextual tokens included in unmasked portions of image data.
O. The system of any one of paragraphs J-N, wherein the second image data is generated based on upsampling the refined version of the image.
P. The system of any one of paragraphs J-O, wherein the second image data is generated based at least on a determination that a number of refinement iterations performed on the first image data meets or exceeds a threshold, the number of refinement iterations determined based at least on a resolution level associated with the image.
Q. The system of any one of paragraphs J-P, wherein the system is comprised in at least one of: a control system for an autonomous or semi-autonomous machine; a perception system for an autonomous or semi-autonomous machine; a system for performing simulation operations; a system for performing digital twin operations; a system for performing light transport simulation; a system for performing collaborative content creation for 3D assets; a system for performing deep learning operations; a system for performing remote operations; a system for performing real-time streaming; a system for generating or presenting one or more of augmented reality content, virtual reality content, or mixed reality content; a system implemented using an edge device; a system implemented using a robot; a system for performing conversational AI operations; a system implementing one or more multi-model language models; a system implementing one or more large language models (LLMs); a system implementing one or more vision language models (VLMs); a system for generating synthetic data; a system for generating synthetic data using AI; a system incorporating one or more virtual machines (VMs); a system implemented at least partially in a data center; or a system implemented at least partially using cloud computing resources.
R. One or more processors comprising processing circuitry to: generate an image having a target resolution based at least on progressively generating higher-resolution versions of the image and, for each respective image of the higher-resolution versions of the image, iteratively refining masked portions of the respective image based at least on (i) unmasked portions of the respective image and (ii) a lower-resolution version of the respective image.
S. The one or more processors of paragraph R, wherein higher-resolution versions of the image are progressively generated based at least on upsampling lower-resolution versions of the image.
T. The one or more processors of any one of paragraphs R-S, wherein the one or more processors are comprised in at least one of: a control system for an autonomous or semi-autonomous machine; a perception system for an autonomous or semi-autonomous machine; a system for performing simulation operations; a system for performing digital twin operations; a system for performing light transport simulation; a system for performing collaborative content creation for 3D assets; a system for performing deep learning operations; a system implemented using an edge device; a system implemented using a robot; a system for performing conversational AI operations; a system implementing one or more multi-model language models; a system implementing one or more large language models (LLMs); a system implementing one or more vision language models (VLMs); a system for generating synthetic data; a system for generating synthetic data using AI; a system incorporating one or more virtual machines (VMs); a system implemented at least partially in a data center; or a system implemented at least partially using cloud computing resources.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. A method comprising:
masking a portion of an image;
generating a refined version of the image based at least on refining the portion of the image as masked using an unmasked portion of the image; and
generating, using the refined version of the image, a higher-resolution version of the image.

2. The method of claim 1, further comprising:
generating the image based on upsampling a lower-resolution version of the image; and
wherein the generating of the refined version of the image is further based on using the lower-resolution version of the image to refine the portion of the image as masked.

3. The method of claim 1, further comprising:
masking a portion of a second image, the second image corresponding to the higher-resolution version of the refined image; and
generating a refined version of the second image by refining the portion of the second image as masked based at least on an unmasked portion of the second image.

4. The method of claim 3, further comprising:
generating, as a third image, a higher-resolution version of the refined second image; and
causing output of the third image on a display associated with a computing device.

5. The method of claim 1, wherein the generating of the refined version of the image comprises performing a plurality of refinement iterations, the method further comprising:
determining that a number of the refinement iterations meets or exceeds a threshold,
wherein the generating of the higher-resolution version of the refined image is based at least on the number meeting or exceeding the threshold.

6. The method of claim 1, wherein the generating of the refined version of the image comprises iteratively refining respective ones of a plurality of masked portions of the image over a plurality of refinement steps based at least on a plurality of unmasked portions of the image.

7. The method of claim 1, wherein the portion of the image as masked comprises one or more masked tokens corresponding to one or more points or pixels of the image, the one or more masked tokens selected based at least on a masking pattern.

8. The method of claim 1, wherein the generating of the refined version of the image comprises predicting, using a predictive model and based at least on the unmasked portion of the image, a value of a token corresponding to a point or pixel within the portion of the image as masked, where the predictive model is trained to generate one or more token values based on one or more contextual tokens included in the unmasked portion of the image.

9. The method of claim 1, wherein the image is progressively refined and upsampled through a hierarchy of two or more resolution levels to generate an updated version of the image having a target resolution.

10. A system comprising one or more processors to:
mask a portion of first image data representing an image;
refine the portion of the first image data based at least on an unmasked portion of the first image data and a lower-resolution version of the image;
generate a refined version of the image that includes at least the portion of the first image data as refined; and
generate second image data representing a higher-resolution version of the refined image.

11. The system of claim 10, the one or more processors further to:
mask one or more second portions of the first image data; and
refine the one or more second portions of the first image data over one or more iterations based at least on one or more second unmasked portion of the first image data and the lower-resolution version of the image,
wherein the refined version of the image further includes the refined one or more second portions.

12. The system of claim 10, the one or more processors further to:
select, based at least on a masking pattern, one or more tokens corresponding to one or more points or pixels included in the portion of the first image data,
wherein the masking of the portion of the first image data is based at least on the selection.

13. The system of claim 12, wherein the masking pattern is selected randomly or determined based on a refinement schedule.

14. The system of claim 10, wherein the refinement of the portion of the first image data comprises predicting a value of a token corresponding to a pixel of the first image data as masked using a predictive model trained to generate token values based on contextual tokens included in unmasked portions of image data.

15. The system of claim 10, wherein the second image data is generated based on upsampling the refined version of the image.

16. The system of claim 10, wherein the second image data is generated based at least on a determination that a number of refinement iterations performed on the first image data meets or exceeds a threshold, the number of refinement iterations determined based at least on a resolution level associated with the image.

17. The system of claim 10, wherein the system is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more multi-model language models;
a system implementing one or more large language models (LLMs);
a system implementing one or more vision language models (VLMs);
a system for generating synthetic data;
a system for generating synthetic data using AI;
a system incorporating one or more virtual machines (VMs);
a system implemented at least partially in a data center; or
a system implemented at least partially using cloud computing resources.

18. One or more processors comprising processing circuitry to:
generate an image having a target resolution based at least on progressively generating higher-resolution versions of the image and, for each respective image of the higher-resolution versions of the image, iteratively refining masked portions of the respective image based at least on (i) unmasked portions of the respective image and (ii) a lower-resolution version of the respective image.

19. The one or more processors of claim 18, wherein higher-resolution versions of the image are progressively generated based at least on upsampling lower-resolution versions of the image.

20. The one or more processors of claim 18, wherein the one or more processors are comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more multi-model language models;
a system implementing one or more large language models (LLMs);
a system implementing one or more vision language models (VLMs);
a system for generating synthetic data;
a system for generating synthetic data using AI;
a system incorporating one or more virtual machines (VMs);
a system implemented at least partially in a data center; or
a system implemented at least partially using cloud computing resources.
